(19) United States
(12) Patent Application Publication
(10) Pub. No.: US 2025/0355926 A1
(43) Pub. Date: Nov. 20, 2025

(54) PROMPT GENERATING SYSTEM

(71) Applicant: KYOCERA Document Solutions Inc., Osaka (JP)

(72) Inventors: Naomichi Higashiyama, Osaka (JP); Yuya Okazaki, Osaka (JP); Kenichi Katsura, Osaka (JP)

(21) Appl. No.: 19/205,663

(22) Filed: May 12, 2025

(30) Foreign Application Priority Data
May 20, 2024 (JP) 2024-082125

(51) Int. Cl. G06F 16/532; G06F 16/535; G06T 11/00

(52) U.S. Cl. CPC G06F 16/532; G06F 16/535; G06T 11/00

(57) ABSTRACT

A prompt generating system includes a user attribute determining unit, a prompt estimating unit, and a generated image acquiring unit. The user attribute determining unit is configured to determine a user attribute. The prompt estimating unit is configured to estimate an adjustment prompt corresponding to the user attribute using a machine-learned prompt estimation model. The generated image acquiring unit is configured to acquire a generated image corresponding to an input prompt that includes the adjustment prompt using an image generation model.

### CROSS-REFERENCE TO RELATED APPLICATIONS

This application relates to and claims priority rights from Japanese Patent Application No. 2024-082125, filed on May 20, 2024, the entire disclosures of which are hereby incorporated by reference herein.

### BACKGROUND

### 1. Field of the Present Disclosure

The present disclosure relates to a prompt generating system.

### 2. Description of the Related Art

In a machine-learned image generation model, an inputted text (prompt) is converted to a characteristic vector, and an image corresponding to the characteristic vector is generated.

In general, when a user acquires a generated image desired by the user using an image generation model as mentioned, the user includes an adjustment prompt (setting on brightness, preciseness, composition and the like) in a prompt to be inputted to the image generation model in order to acquire a generated image that has a property required by the user.

However, the user may hardly specify a proper adjustment prompt due to a proficiency level or knowledge of the user.

### SUMMARY

A prompt generating system according to an aspect of the present disclosure includes a user attribute determining unit, a prompt estimating unit, and a generated image acquiring unit. The user attribute determining unit is configured to determine a user attribute. The prompt estimating unit is configured to estimate an adjustment prompt corresponding to the user attribute using a machine-learned prompt estimation model. The generated image acquiring unit is configured to acquire a generated image corresponding to an input prompt that includes the adjustment prompt using an image generation model.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of a prompt generating system according to an embodiment of the present disclosure;

FIG. 2 shows a diagram that explains a user attribute and an adjustment prompt;

FIG. 3 shows a diagram that explains generation of plural generated images;

FIG. 4 shows a flowchart that explains a behavior of an image forming apparatus 1 shown in FIG. 1; and

FIG. 5 shows a flowchart that explains a behavior of a management server 3 shown in FIG. 1.

### DETAILED DESCRIPTION

Hereinafter, an embodiment according to an aspect of the present disclosure will be explained with reference to drawings.

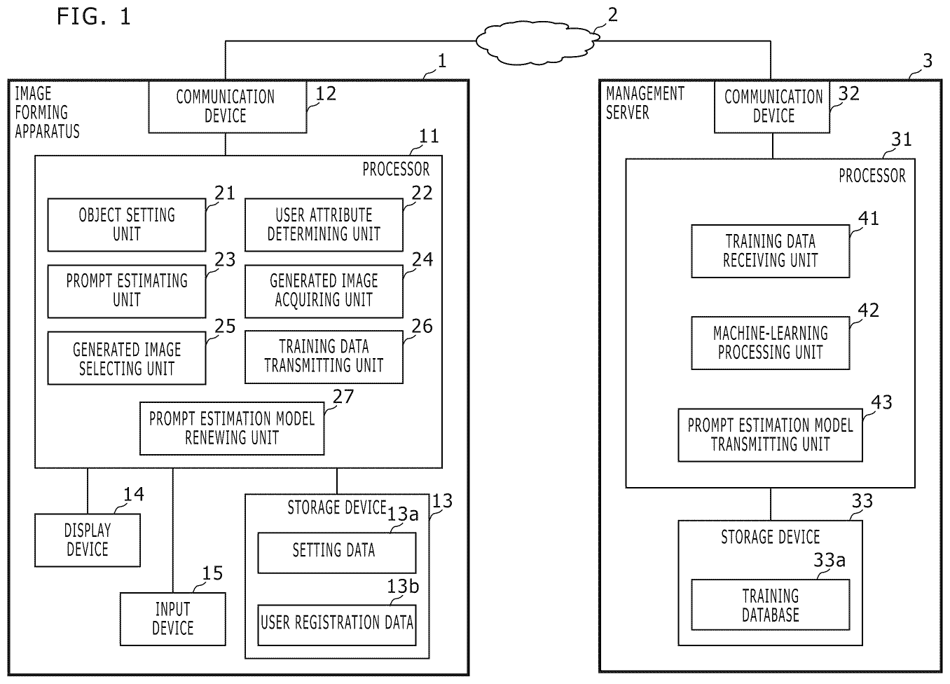

FIG. 1 shows a block diagram that indicates a configuration of a prompt generating system according to an embodiment of the present disclosure. The prompt generating system shown in FIG. 1 includes an image forming apparatus 1 and a management server 3 capable of data communication with the image forming apparatus 1 through a computer network 2.

The image forming apparatus 1 is an electronic apparatus such as multi function peripheral, and includes a processor 11 as a computer, a communication device 12, a storage device 13, a display device 14, and an input device 15.

The communication device 12 is a device (network interface or the like) capable of data communication with another device (here the management server 3 and the like) through the computer network 2 such as Internet or intranet. The storage device 13 is a nonvolatile storage device such as flash memory or hard disk and stores a program and data. In the storage device 13, setting data 13a, user registration data 13b and the like mentioned below have been stored. The user registration data 13b includes a user ID and a user attribute of each registration user. For example, the user registration data 13b is used for user authentication when logging-in. The display device 14 is a device such as liquid crystal display, that displays an operation screen, a generated image mentioned below, and the like. The input device 15 is a device such as touch panel or hard key, that detects a user operation.

Here, the processor 11 executes a program stored in the storage device 13 and thereby acts as an object setting unit 21, a user attribute determining unit 22, a prompt estimating unit 23, a generated image acquiring unit 24, a generated image selecting unit 25, a training data transmitting unit 26, and a prompt estimation model renewing unit 27.

The object setting unit 21 sets a type of an object to be included in a generated image. The type of the object is specified by a user who requested image generation. For example, if “Orange” is specified as the type of the object, “Orange” is included in an input prompt, and a generated image that includes an image of an orange is generated.

The user attribute determining unit 22 determines a user attribute of the user who requested image generation. Specifically, the user attribute determining unit 22 refers to the user registration data 13b and thereby determines the user attribute.

The prompt estimating unit 23 estimates an adjustment prompt corresponding to the user attribute using a machine-learned prompt estimation model. The prompt estimation model is a learner (for example, deep neural network or the like) that has a parameter value obtained by machine learning mentioned below, and the parameter value is stored as the setting data 13 in the storage device 13.

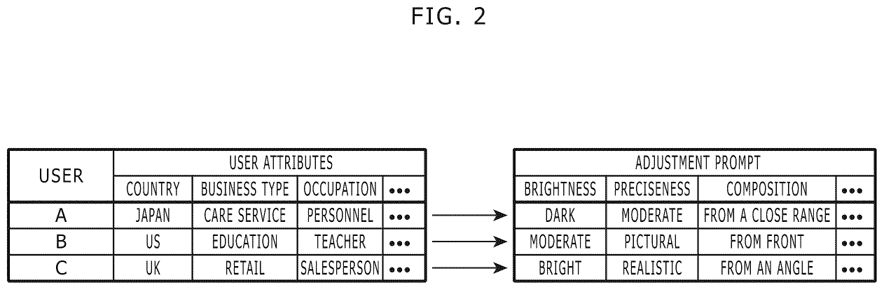

FIG. 2 shows a diagram that explains a user attribute and an adjustment prompt. As shown in FIG. 2, for example, the user attribute is a country of a user (a country that the user lives in, a country that the user has his/her nationality, or the like), a business type of a user, an occupation of a user and/or the like, and the adjustment prompt specifies an image property (a setting value of an item such as brightness, preciseness and/or composition) of the object specified by the object type in a generated image.

The generated image acquiring unit 24 acquires a generated image corresponding to an input prompt using an image generation model, and the input prompt includes the adjustment prompt acquired by the prompt estimating unit 23. The input prompt includes not only the adjustment prompt but the aforementioned object type.

The image generation model is a learner that has been machine-learned in accordance with an existing method, and generates image data (i.e. a generated image) corresponding to the input prompt. The generated image acquiring unit 24 may include the image generation model, or may access an external server that the image generation model is installed, transmit the input prompt to the external server, and acquire a generated image from the external server.

Here, the prompt estimating unit 23 estimates plural adjustment prompts corresponding the user attribute for a prompt type (i.e. the aforementioned item of the image property) using the prompt estimation model, and the generated image acquiring unit 24 acquires plural generated images corresponding to plural input prompts that include the plural adjustment prompts respectively, using the image generation model.

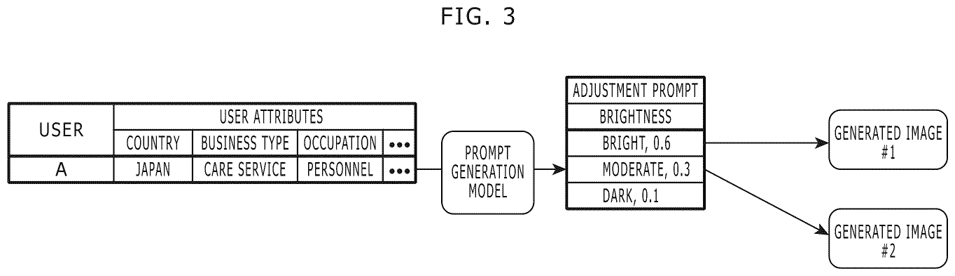

FIG. 3 shows a diagram that explains generation of plural generated images. As shown in FIG. 3, for example, the prompt estimating unit 23 derives confidences (values in a range from 0 to 1) of a predetermined number of adjustment prompts (the setting values) for each prompt type, using the prompt estimation model; and the plural adjustment prompts used for the plural generated images are selected among the predetermined number of the adjustment prompts on the basis of the confidences derived by the prompt estimation model. As shown in FIG. 3, for example, regarding brightness as a prompt type (item), two setting values “bright” and “moderate” are selected among “bright” (confidence 0.6), “moderate” (confidence 0.3), and “dark” (confidence 0.1); and two generated images corresponding to the selected two setting values are generated. Therefore, generated are a generated image #1 of a high brightness and a generated image #2 of which the brightness is a moderate value.

The generated image selecting unit 25 selects a generated image specified by a user among the plural generated images acquired by the generated image acquiring unit 24.

When the generated image specified by a user is selected, the training data transmitting unit 26 determines a user attribute of a user who requested image generation and the adjustment prompt corresponding to the selected generated image as a pair of training data (a pair of an explanatory variable and a response variable, i.e. a pair of input data and output data of the model), and transmits the training data to the management server 3 using the communication device 12.

For example, the user who requested image generation is identified with a user ID when the user logs in the image forming apparatus 1 or identified with a user ID included in the request received from an external host device.

Further, as shown in FIG. 2, for example, if a user A selects a generated image that was generated with an adjustment prompt that the item “brightness” is “dark”, the item “preciseness” is “moderate”, and the item “composition” is “from a close range”, then generated and transmitted is the training data that the user attributes (Country, Business type, Occupation) are (“Japan”, “Care service”, “Personnel”) and the adjustment parameters (Brightness, Preciseness, Composition) are (“Dark”, “Moderate”, “From a close range”).

The prompt estimation model renewing unit 27 (a) acquires initial values of parameters of the prompt estimation model from the management server 3 and stores the initial values as the setting data 13a into the storage device 3 and thereby sets the initial values to the prompt estimation model, and (b) receives renewal values of the parameters of the prompt estimation model from the management server 3 and upon receiving the renewal values, renews the setting data 13a with the renewal values and thereby renews the prompt estimation model.

Further, the management server 3 includes a processor 31 as a computer, a communication device 32, and a storage device 33.

The communication device 32 is a device (network interface or the like) capable of data communication with another device (here the image forming apparatus 1 and the like) through the computer network 2 such as Internet or intranet. The storage device 33 is a nonvolatile storage device such as flash memory or hard disk and stores a program and data. In the storage device 33, a training database 33a and the like mentioned below have been stored.

Here, the processor 31 executes a program stored in the storage device 33 and thereby acts as a training data receiving unit 41, a machine-learning processing unit 42, and a prompt estimation model transmitting unit 43.

The training data receiving unit 41 repeatedly receives training data as mentioned from one or more image forming apparatuses 1 through the computer network 2 using the communication device 32, performs an embedding process for the received training data and thereby converts the training data to a pair of characteristic vectors, and stores the pair of the characteristic vectors to the training database 33a in the storage device 33.

In this embedding process, a user attribute as input data in training data and an adjustment prompt (setting value) as output data in training data are converted to one hot characteristic vectors (for items, respectively). This embedding process may be performed by the training data receiving unit 41 or may be performed by the training data transmitting unit 26 before the transmission.

The machine-learning processing unit 42 performs machine learning of the prompt estimation model in accordance with an existing method with a predetermined number or more of training data of which each pair includes the user attribute and the adjustment prompt corresponding to the selected generated image piled in the training database 33a (specifically, each pair includes a characteristic vector of the user attribute and a characteristic vector of the adjustment prompt), and thereby derives parameter values of the prompt estimation model.

The prompt estimation model transmitting unit 43 transmits the parameter values derived in the machine learning to the image forming apparatus 1 (the prompt estimation model renewing unit 27) using the communication device 32 and causes the prompt estimation model renewing unit 27 to renew the prompt estimation model with the parameter values.

Here, for each prompt type of predetermined plural prompt types, the prompt estimating unit 23 estimates an adjustment prompt corresponding to the user attribute using a machine-learned prompt estimation model for the prompt type, and the generated image acquiring unit 24 acquires a generated image corresponding to an input prompt that includes the adjustment prompt of the plural prompt types using an image generation model. Therefore, the machine-learning processing unit 42 performs machine learning of the prompt estimation model for each prompt type.

It should be noted that the management server 3 receives the aforementioned training data from plural image forming apparatuses 1.

The following part explains a behavior of the aforementioned prompt generating system.

### (a) Behavior of the Image Forming Apparatus 1

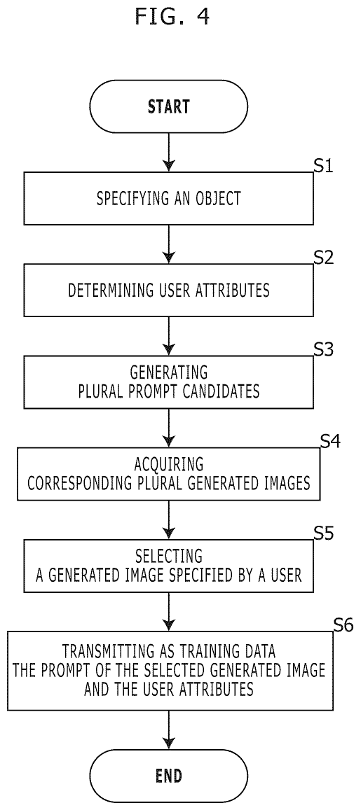

FIG. 4 shows a flowchart that explains a behavior of the image forming apparatus 1 shown in FIG. 1.

In the image forming apparatus 1, when the input device 15 detects a predetermined user operation (image generation request) of a user, the object setting unit 21 sets a type of an object on the basis of the user operation (in Step S1) and determines a user attribute of the user on the basis of the user operation (in Step S2).

For each prompt type of predetermined plural prompt types, the prompt estimating unit 23 estimates an adjustment prompt corresponding to the user attribute using a machine-learned prompt estimation model for the prompt type and thereby generates plural input prompt candidates (in Step S3) and the generated image acquiring unit 24 acquires plural generated images corresponding to the plural input prompt candidates using the image generation model (in Step S4).

Subsequently, the generated image selecting unit 25 displays the acquired plural generated images on the display device 14, and when the input device 15 detects a user operation that specifies a generated image desired by a user among the displayed plural generated images, the generated image selecting unit 25 selects the generated image desired by the user among the plural generated images (in Step S5). The selected generated image is stored in the storage device 13 or used in a subsequent process.

When the generated image is selected as mentioned, the training data transmitting unit 26 transmits as training data a pair of user attribute information that indicates the aforementioned user attribute and the adjustment prompt used for the selected generated image to the management server 3 using the communication device 12 (in Step S6).

As mentioned, every time when the generated image is selected by the user, the training data is transmitted from the image forming apparatus 1 to the management server 3.

### (b) Behavior of the Management Server 3

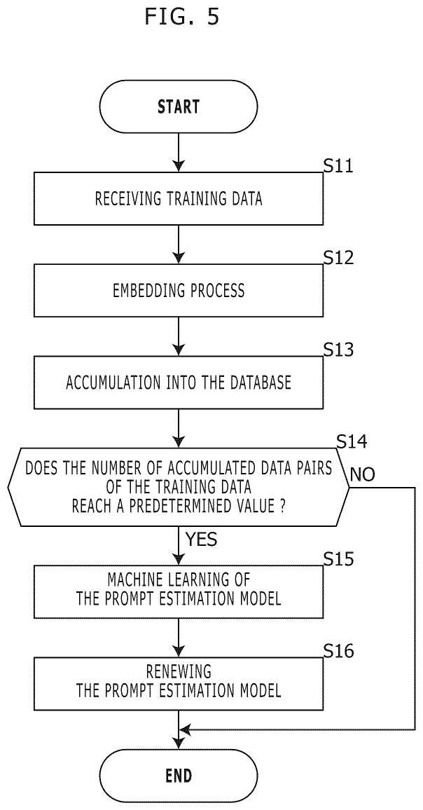

FIG. 5 shows a flowchart that explains a behavior of the management server 3 shown in FIG. 1.

In the management server 3, when the training data is transmitted from the image forming apparatus 1 to the management server 3, the training data receiving unit 41 receives the training data using the communication device 32 (in Step S11), performs an embedding process for the training data (in Step S12), and after the embedding process, piles the embedded training data in the training database 33a (in Step S13).

The machine-learning processing unit 42 determines whether the number of the data pairs piled in the training database 33a reaches a predetermined number or not (in Step S14).

When the number of the data pairs piled in the training database 33a reaches the predetermined number, the machine-learning processing unit 42 performs machine learning of the prompt estimation model on the basis of the data pairs currently piled in the training database 33a and thereby derives parameter values of the prompt estimation model (in Step S15). For example, every time when the number of the data pairs increases by the predetermined number, the machine learning is performed.

Subsequently, the prompt estimation model transmitting unit 43 transmits the derived parameter values of the prompt estimation model to the image forming apparatus 1 using the communication device 32 (in Step S16). In the image forming apparatus 1, the prompt estimation model renewing unit 27 receives the parameter values using the communication device 12 and renews the prompt estimation model with the received parameter values.

As mentioned, every time when the training data is received from any of the image forming apparatuses 1, the training data is piled, and the machine learning of the prompt estimation model is timely repeatedly performed and thereby the prompt estimation model is renewed.

As mentioned, in the aforementioned embodiment, the user attribute determining unit 22 determines a user attribute. The prompt estimating unit 23 estimates an adjustment prompt corresponding to the determined user attribute using a machine-learned prompt estimation model.

Using an image generation model, the generated image acquiring unit 24 acquires a generated image corresponding to an input prompt that includes the estimated adjustment prompt.

Consequently, a proper adjustment prompt to be inputted to the image generation model is provided, and obtained is a generated image that has image characteristics corresponding to a user attribute (i.e. a generated image that tends to be preferred by a user of the used user attribute).

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. A prompt generating system, comprising:
a user attribute determining unit configured to determine a user attribute;
a prompt estimating unit configured to estimate an adjustment prompt corresponding to the user attribute using a machine-learned prompt estimation model; and
a generated image acquiring unit configured to acquire a generated image corresponding to an input prompt that includes the adjustment prompt using an image generation model.

2. The prompt generating system according to claim 1, further comprising a generated image selecting unit;
wherein the prompt estimating unit estimates plural adjustment prompts corresponding the user attribute for a prompt type using the machine-learned prompt estimation model;
the generated image acquiring unit acquires plural generated images corresponding to plural input prompts that include the plural adjustment prompt respectively, using the image generation model; and
the generated image selecting unit selects a generated image specified by a user among the plural generated images.

3. The prompt generating system according to claim 2, wherein the plural adjustment prompts are selected a among predetermined number of adjustment prompts on the basis of confidences derived by the prompt estimation model.

4. The prompt generating system according to claim 2, further comprising a machine-learning processing unit;
wherein the machine-learning processing unit performs machine learning of the prompt estimation model using training data that includes a pair of the user attribute of the user and an adjustment prompt corresponding to the selected generated image.

5. The prompt generating system according to claim 4, wherein for each prompt type of predetermined plural prompt types, the prompt estimating unit estimates an adjustment prompt corresponding to the user attribute using a machine-learned prompt estimation model for the prompt type; and
the generated image acquiring unit acquires a generated image corresponding to an input prompt that includes the adjustment prompt of the plural prompt types using an image generation model; and
the machine-learning processing unit performs machine learning of the prompt estimation model for each of the prompt types.
